(19) United States
(12) Patent Application Publication
(10) Pub. No.: US 2025/0278944 A1
(43) Pub. Date: Sep. 4, 2025

(54) APPARATUS, METHOD, AND NON-TRANSITORY COMPUTER-READABLE MEDIUM FOR DETECTING MOVING OBJECT

(71) Applicant: HONDA MOTOR CO., LTD., Tokyo (JP)

(72) Inventors: Riku INOUE, Wako-shi (JP); Masamitsu TSUCHIYA, Wako-shi (JP)

(21) Appl. No.: 19/053,762

(22) Filed: Feb. 14, 2025

(30) Foreign Application Priority Data
Mar. 4, 2024 (JP) 2024-032497

(51) Int. Cl. G06V 20/58; B60W 60/00; G06T 7/246; G06T 7/73; G06V 10/75; G06V 10/77

(52) U.S. Cl. CPC G06V 20/58; G06T 7/248; G06T 7/74; G06V 10/751; G06V 10/7715; B60W 60/001; B60W 2420/403; G06T 2207/30244; G06T 2207/30252; G06V 2201/08

(57) ABSTRACT

An apparatus for detecting a moving object is provided. The apparatus generates a feature of each image in a plurality of frames. The apparatus generates a cost volume indicating likelihood of matching between the plurality of frames for each depth based on the feature of the image. The apparatus generates a feature indicating a distribution of values in a depth direction in the cost volume. The apparatus detects a moving object in the image based on the feature indicating the distribution of values in the depth direction.

### CROSS-REFERENCE TO RELATED APPLICATION(S)

This application claims priority to and the benefit of Japanese Patent Application No. 2024-032497, filed Mar. 4, 2024, the entire disclosure of which is incorporated herein by reference.

### BACKGROUND OF THE INVENTION

### Field of the Invention

The present invention relates to an apparatus, a method, and a non-transitory computer-readable medium, and particularly to detection of a moving object from an image.

### Description of the Related Art

In recent years, a technique for recognizing an object in an image by using a trained model has been proposed. In particular, a technique for detecting all moving objects in an image in order to enable detection of an object of a class that has not been trained by a normal object detector has been examined. For example, Siam (M. Siam et al. “Video Class Agnostic Segmentation Benchmark for Autonomous Driving”, Computer Vision and Pattern Recognition 2021, arXiv:2103.11015.) performs Optical Flow calculation and ego flow suppression processing using FlowNet-2 and inputs the result to a ResNet-based neural network, thereby implementing highly accurate moving object detection.

### SUMMARY OF THE INVENTION

According to an embodiment, an apparatus comprises one or more memories storing instructions and one or more processors that execute the instructions to: generate a feature of each image in a plurality of frames; generate a cost volume indicating likelihood of matching between the plurality of frames for each depth based on the feature of the image; generate a feature indicating a distribution of values in a depth direction in the cost volume; and detect a moving object in the image based on the feature indicating the distribution of values in the depth direction.

According to another embodiment, a detection method comprises: generating a feature of each image in a plurality of frames; generating a cost volume indicating likelihood of matching between the plurality of frames for each depth based on the feature of the image; generating a feature indicating a distribution of values in a depth direction in the cost volume; and detecting a moving object in the image based on the feature indicating the distribution of values in the depth direction.

According to still another embodiment, a non-transitory computer-readable medium stores a program executable by a computer to perform a method comprising: generating a feature of each image in a plurality of frames; generating a cost volume indicating likelihood of matching between the plurality of frames for each depth based on the feature of the image; generating a feature indicating a distribution of values in a depth direction in the cost volume; and detecting a moving object in the image based on the feature indicating the distribution of values in the depth direction.

### BRIEF DESCRIPTION OF THE DRAWINGS

FIG. 1 is a hardware configuration diagram of a detection apparatus according to an embodiment;

FIG. 2 is a functional configuration diagram of the detection apparatus according to the embodiment;

FIG. 3 is a diagram illustrating an example of a configuration of a moving object detection model used in the embodiment;

FIG. 4 is a diagram illustrating an example of a configuration of a three-dimensional convolution network used in the embodiment;

FIG. 5 is a flowchart of a detection method according to the embodiment;

FIG. 6 is a functional configuration diagram of a vehicle according to the embodiment; and

FIGS. 7A and 7B are diagrams illustrating a relationship between the number of blocks in a network and detection accuracy.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

The moving object detector that has been currently proposed and has high accuracy as described in Siam uses a large-scale model. On the other hand, when moving object detection is performed in real time as in an automated driving system or an emergency avoidance system of a vehicle, it is desirable to use a lightweight model capable of high-speed operation while having relatively high accuracy.

An embodiment of the present invention can perform moving object detection from an image at a high speed.

Hereinafter, a configuration of a detection apparatus 100 according to the embodiment of the present invention will be described in more detail. The detection apparatus 100 can detect a moving object based on the captured image. The type of moving object is not particularly limited. The moving object may include, for example, at least one of a vehicle, a person, an animal such as a dog or a cat, and a two-wheeled vehicle.

The detection apparatus 100 can be realized using a computer. Examples of the computer include a general-purpose desktop computer, a server, and an embedded device. For example, the function of each processing unit included in the detection apparatus 100 illustrated in FIG. 2 can be realized by a computer. However, at least some of the processing units may be realized by dedicated hardware. Furthermore, the detection apparatus may include, for example, a plurality of information processing devices connected via a network. For example, the function of the detection apparatus may be provided as a cloud service.

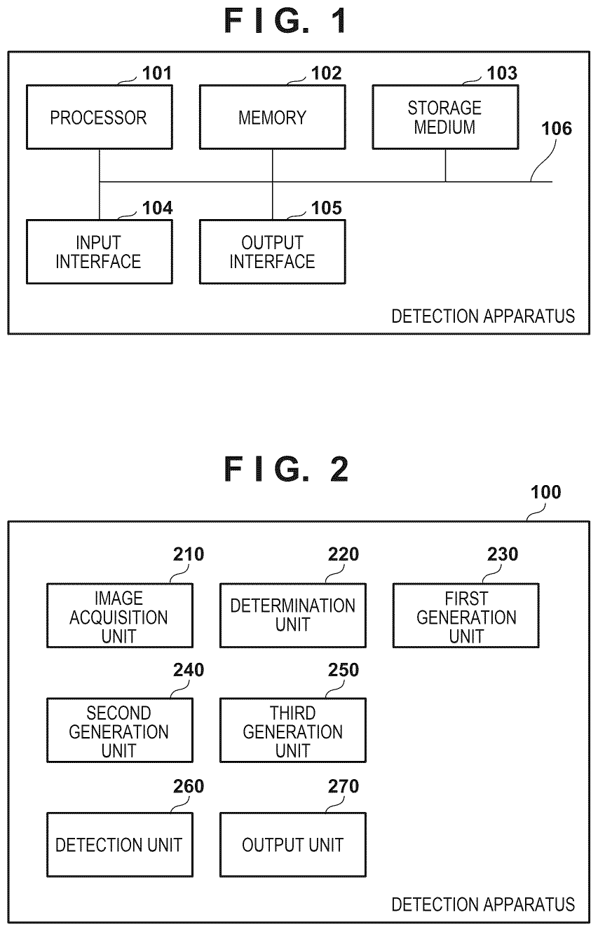

FIG. 1 is a diagram illustrating a basic configuration of a computer. In FIG. 1, a processor 101 is, for example, a CPU, and controls the operation of the entire computer. The memory 102 is, for example, a RAM, and temporarily stores programs, data, and the like. A computer-readable storage medium 103 is, for example, a hard disk, a CD-ROM, or the like, and stores programs, data, and the like for a long time. In the present embodiment, a program that implements the function of each unit and is stored in the storage medium 103 is read into the memory 102. The processor 101 operates in accordance with the program on the memory 102, thereby implementing the functions of the respective units.

In FIG. 1, an input interface 104 is an interface for acquiring information from an external device. An output interface 105 is an interface for outputting information to an external device. A bus 106 connects the above-described units and enables transmission and reception of data.

Next, an example of a functional configuration of the detection apparatus 100 according to the embodiment will be described with reference to FIG. 2. The detection apparatus 100 includes a first generation unit 230, a second generation unit 240, a third generation unit 250, and a detection unit 260. The detection apparatus 100 may further include an image acquisition unit 210, a determination unit 220, and an output unit 270.

The image acquisition unit 210 acquires each image in a plurality of frames. For example, the determination unit can acquire an image Iₜ in a frame at a time point t as a detection target for a moving object and an image Iₜ₋₁ in a frame at a time point t−1 before the time point t. The plurality of frames are frames at different time points. For example, the plurality of frames may be consecutive frames.

In the present embodiment, each image acquired by the image acquisition unit 210 is captured by the same image capturing apparatus. However, the position of the image capturing apparatus when each image is captured may change.

The determination unit 220 determines a posture change of the image capturing apparatus that has captured an image between a plurality of frames. The determination unit 220 can determine a posture change of the image capturing apparatus based on each image acquired by the image acquisition unit 210. A specific method is not particularly limited. For example, the determination unit 220 can determine the posture change using a Pose Network 310 which will be described later. The determination unit 220 may determine the posture change by another method using matching between images. On the other hand, it is not essential that the determination unit 220 determines the posture change of the image capturing apparatus. For example, the image capturing apparatus may be provided in a vehicle. At this time, a control unit included in the vehicle can determine the posture change of the image capturing apparatus based on information indicating the movement of the vehicle, such as acceleration information acquired by a sensor. In such a case, the determination unit 220 may acquire information indicating the posture change of the image capturing apparatus determined by another device. In the present embodiment, the posture change of the image capturing apparatus refers to at least one of a position change (for example, a translation vector) and a posture change (for example, a rotation matrix) of the image capturing apparatus.

The first generation unit 230 generates a feature of each image in a plurality of frames. A method of generating the feature is not particularly limited. For example, the first generation unit 230 can generate the feature of an image using a neural network. As a specific example, the first generation unit 230 can generate the feature of each image by inputting each image to a Feature Network 320 which will be described later. The first generation unit 230 can generate the feature of each of the image Iₜ and the image Iₜ₋₁ using the common parameter. The feature of the image Iₜ generated by the first generation unit 230 is referred to as a feature map F¹ₜ. The feature of the image Iₜ₋₁ generated by the first generation unit 230 is referred to as a feature map F¹ₜ₋₁.

The first generation unit 230 may generate a plurality of types of features of an image for further processing. For example, the first generation unit 230 can further generate a feature map F²ₜ and a feature map F³ₜ having different scales from the feature map F¹ₜ, as the feature of the image Iₜ.

The second generation unit 240 generates a cost volume indicating the likelihood of matching between the plurality of frames for each depth based on the feature of the image. The cost volume indicates matching between two images or between feature maps of two images. More specifically, the cost volume indicates the correctness of matching when matching is performed in accordance with each depth value, for each position in a spatial direction (vertical and horizontal directions of the image). In other words, the cost volume indicates the cost (or likelihood) for each depth value for each location. For example, for a specific position, the depth value corresponding to the smallest cost represents the most likely depth to a subject appearing at this specific position.

In the present embodiment, the second generation unit 240 generates the cost volume based on the difference between the feature map F¹ₜ₋₁ and the feature map F¹ₜ aligned based on the posture change and each depth of the image capturing apparatus. For example, the second generation unit 240 warps a source feature map (F¹ₜ₋₁) onto a target feature map (F¹ₜ) by using one (dᵢ) of discrete values of the depth included within a specific depth range dₘₐₓ to dₘᵢₙ and ego-motion between the respective frames. The ego-motion corresponds to the posture change of the image capturing apparatus determined by the determination unit 220. Specifically, the second generation unit 240 warps the feature map F¹ₜ₋₁ on the plane of the depth value dᵢ to a viewpoint of the image capturing apparatus in the frame at a time point t−1 based on the ego-motion between the frames. Further, the second generation unit 240 calculates a difference between the warped feature map and the target feature map. The second generation unit 240 generates the cost volume by performing such processing using each of a plurality of depth values within the depth range dₘₐₓ to dₘᵢₙ. For example, the second generation unit 240 can generate the cost volume by using Warping processing 330 and 11 distance calculation processing 340 which will be described later.

A method of setting the depth range, that is, the upper limit value dₘₐₓ of the depth range and the lower limit value dₘᵢₙ of the depth range is not particularly limited. A method of setting the number of depth values or the interval between the depth values is not particularly limited. These values may be set in advance. For example, these values can be set manually. In the present embodiment, as described later, the moving object detection is performed based on the distribution of the cost in the depth direction. In such a configuration, it is not necessary to set the depth range to include all depth values up to each subject in an image capturing range. For example, it is not necessary to set the depth range to include the depth of the background. In an embodiment, the depth range can be set in advance based on the depth value of the moving object in the image. For example, the depth range can be set to include each depth value up to most moving objects. The depth range can be set in accordance with a use case. For example, when an image capturing apparatus mounted on a vehicle is used to perform moving object detection for the purpose of driving assistance, the depth range can be set to include the depth of a subject located at a distance that may interfere with traffic. With such a configuration, it is possible to increase the detection speed of the moving object by reducing the size of the cost volume, while maintaining the detection accuracy of the moving object.

For example, a depth image can be obtained by inputting a captured image to a Depth Network such as ManyDepth. The depth range can be set based on a depth value distribution in a region where the moving object exists in the depth image. For example, the depth range may be set to coincide with the range of the depth value distribution. For example, the depth range may also be set to coincide with the range of the depth value distribution after excluding the outlier. The processing of setting such a depth range can be performed using a depth image obtained for a typical captured image. That is, the moving object detection in a plurality of frames can be performed in accordance with a specific depth range set in this manner.

The second generation unit 240 may generate a four-dimensional cost volume. In an embodiment, the feature maps F¹ₜ and F¹ₜ₋₁ generated by the first generation unit 230 have dimensions of C×H×W. The warped feature map has dimensions of D×C×H×W. Here, D represents the number of depth values, C represents the number of channels, H represents the number of elements in the vertical direction, and W represents the number of elements in the horizontal direction. In this case, the first generation unit 230 calculates the absolute distance between the warped feature map and the target feature map (F¹Iₜ) for each depth value. As a result, the first generation unit 230 generates a four-dimensional cost volume having dimensions of D×C×H×W.

The distribution of the cost in the depth direction at a specific spatial position, which is indicated by the cost volume generated by the second generation unit 240, will be discussed. When there is no movement in the subject appearing at this position between frames, it is considered that the cost is the smallest in the most likely depth to the subject appearing at this position. In addition, as the depth value becomes larger or smaller, it is considered that the cost gradually increases. As described above, when there is no movement in the subject between frames, the cost tends to regularly change in the depth direction. On the other hand, when there is movement in the subject appearing at this position between frames, the cost changes irregularly as compared with the neighbor position. This is because, when the warp processing is performed, ego-motion is taken into consideration but the motion of the moving object is not taken into consideration. Thus, when the cost volume has an irregular cost distribution in the depth direction in a specific region, it is likely that a moving object exists in this region. Thus, in the present embodiment, processing for capturing an irregular value of the cost volume is performed.

The third generation unit 250 generates a feature indicating a distribution of values in the depth direction in the cost volume. By referring to such a feature, an irregular cost distribution in the depth direction can be captured. The third generation unit 250 can extract a feature indicating the motion of the subject between frames by performing processing of aggregating information in the depth direction with respect to the cost volume. The third generation unit 250 can perform convolution processing on the cost volume in the depth direction in order to aggregate the information in the depth direction. For example, the third generation unit 250 can generate the feature by using a network 350 which will be described later.

As described above, in an embodiment, the cost volume is a four-dimensional cost volume having dimensions of D×C×H×W. The third generation unit 250 can generate a Channel-wise Motion Feature in which information in the depth direction is aggregated, for such a four-dimensional cost volume. For example, the third generation unit 250 can aggregate information in the depth direction by inputting the cost volume to a network such as a three-dimensional CNN. The Channel-wise Motion Feature can have dimensions of C×H×W. However, the values of C, H, and W do not need to coincide between the four-dimensional cost volume and the Channel-wise Motion Feature.

The configuration of the network used by the third generation unit 250 can be appropriately selected. The third generation unit 250 may perform convolution processing on the cost volume using a network including a Down Sampling Block and an Up Sampling Block. In particular, by using a network including a plurality of Down Sampling Blocks and a plurality of Up Sampling Blocks, the detection accuracy of the moving object is improved. Furthermore, by using a network including two Down Sampling Blocks and two Up Sampling Blocks, it is possible to realize both high accuracy and low calculation cost.

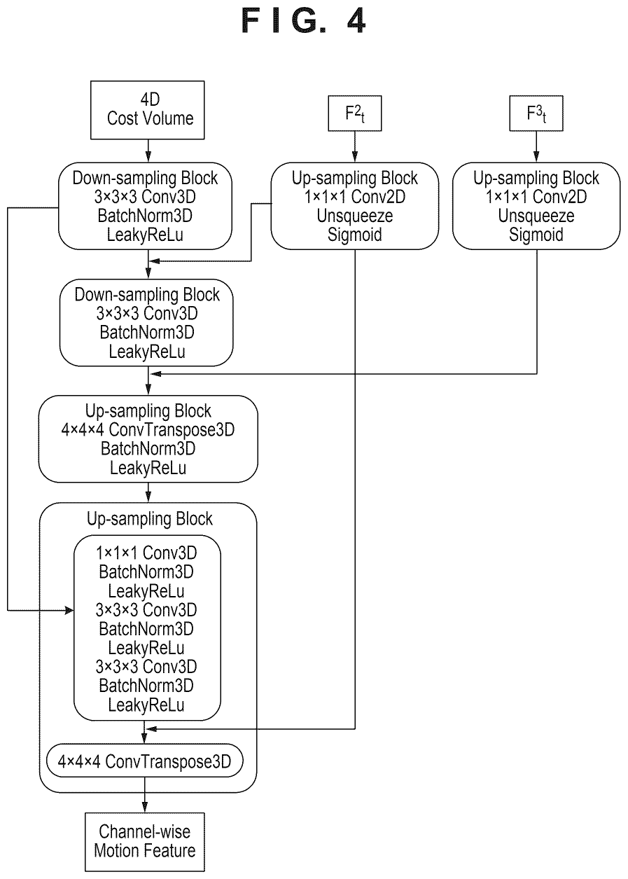

Furthermore, the third generation unit 250 may use a three-dimensional normalization network. A feature map F²ₜ and a feature map F³ₜ having different scales from the feature map F¹ₜ may be further input to the network. As such a network, a network illustrated in FIG. 4 which will be described later can be used.

The detection unit 260 detects a moving object in an image based on the feature indicating the distribution of the values in the depth direction. The detection unit 260 can generate a mask indicating the moving object in the image by using, for example, an Instance Segmentation method. In the Instance Segmentation method, a mask is generated under the idea that the activation of the feature map represents an instance. As described above, the third generation unit 250 aggregates the information in the depth direction, whereby three-dimensional information regarding each instance is aggregated in the feature map generated by the third generation unit 250. That is, the feature map expresses the feature related to each instance activation, and therefore the Instance Segmentation method can be applied. The detection unit 260 can generate a mask indicating the moving object in the image by using, for example, a segmentation decoder 360 which will be described later.

The output unit 270 outputs a detection result of the moving object. For example, the output unit 270 can output a mask indicating a moving object in the image generated by the detection unit 260. The output destination of the detection result is not particularly limited. For example, the output unit 270 may display the detection result on a display via the output interface 105. The output unit 270 may output the detection result to another processing device. For example, the output unit 270 may output the detection result to a controller 607 that controls driving of a vehicle 600 as will be described later.

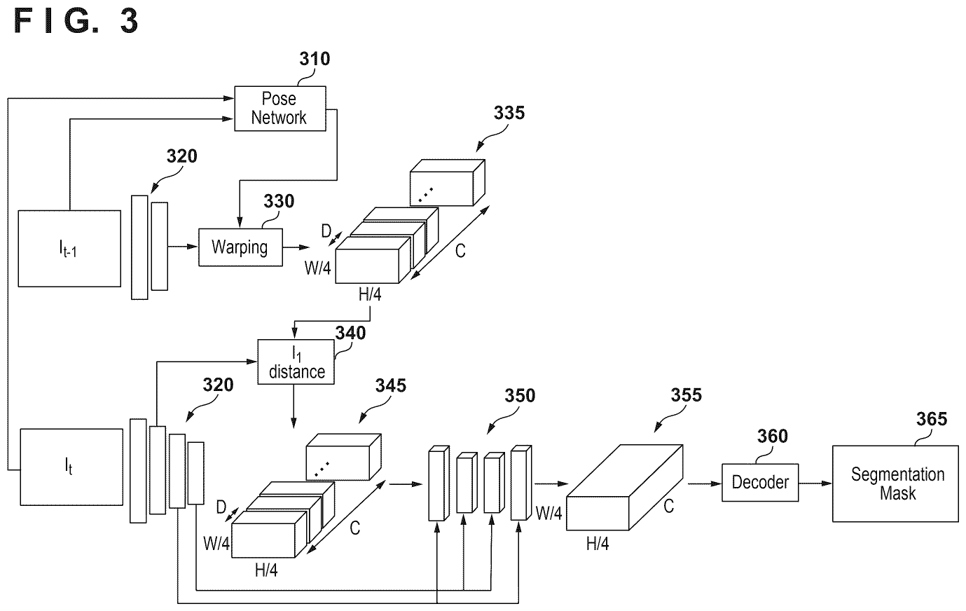

As described above, the first generation unit 230, the second generation unit 240, the third generation unit 250, and the detection unit 260 can perform processing by using a trained model. An example of the trained model will be described below with reference to FIG. 3.

An image Iₜ₋₁ in a frame at a time point t−1 and an image It in a frame at a time point t, which are obtained by the image capturing apparatus, are input to the Pose Network 310. The image Iₜ₋₁ and the image It are images of three channels (for example, RGB channels). The Pose Network 310 estimates Ego-motion of the image capturing apparatus at the time point t−1→t. That is, the Pose Network 310 estimates a relative posture T_{t→t-1} between the posture of the image capturing apparatus at the time point t and the posture of the image capturing apparatus at the time point t−1. As the Pose Network 310, one disclosed in Watson (J. Watson et al. “The Temporal Opportunist: Self-Supervised Multi-Frame Monocular Depth”, Computer Vision and Pattern Recognition 2021, arXiv: 2104.14540.) can be used.

The image Iₜ₋₁ is input to the Feature Network 320. Similarly, the image It is also input to the Feature Network 320. The Feature Network 320 extracts the image feature of the input image by using a common weight parameter. Specifically, the Feature Network 320 generates a feature map F¹ₜ₋₁ from the image Iₜ₋₁. The Feature Network 320 generates feature maps F¹ₜ, F²ₜ, and F³ₜ from the image Iₜ. The resolutions of the feature maps F¹, F², and F³ are ¼, ⅛, and 1/16 of the input image, respectively. As the Feature Network 320, the first four layers of ResNet50 disclosed in He (K. He et al. “Deep Residual Learning for Image Recognition”, Computer Vision and Pattern Recognition 2015, arXiv: 1512.03385.) can be used. In the example of FIG. 3, the resolutions of the image Iₜ and the image Iₜ₋₁ are vertical H pixels and horizontal W pixels. In addition, the number of elements of the feature map F¹ₜ and the feature map F¹ₜ₋₁ is vertical H/4 elements and horizontal W/4 elements.

Warping processing 330 is performed on the feature map F¹ₜ₋₁. In the Warping processing 330, the feature map F¹ₜ₋₁ is warped to the viewpoint of the image capturing apparatus at the time point t by using the plane of the depth value di based on the relative posture estimated by the Pose Network 310. In the Warping processing 330, a warp result using each of a plurality of depth values di is obtained. The plurality of depth values di are values at equal intervals in the depth ranges dₘₐₓ to dₘᵢₙ. As described above, the depth range can be set based on the depth value distribution of the assumed moving object. dₘₐₓ may be, for example, 4.0. In addition, dₘᵢₙ may be, for example, 0.1.

In this example, the Warped Feature 335 having the elements of D×C×H/4×W/4 is obtained by the Warping processing 330 on the feature map F¹ₜ₋₁ with the number of channels C. Here, D represents the number of depth values, and C represents the number of channels. H and W represent the resolution of the image Iₜ₋₁ as described above. The Warped Feature 335 is expressed by the following expression.

$${F}_{t - 1 \to t} ( {d}_{i} ) = {F}_{t - 1} < proj ( {d}_{i} , {T}_{t \to t - 1} , K ) >$$

Here, proj ( ) is a projection function, and gives two-dimensional coordinates at the depth of di in the feature map F¹ₜ₋₁. < > is a sampling operator. K is a 3×3 camera internal parameter.

1₁ distance calculation processing 340 between the Warped Feature 335 obtained in this manner and the feature map F¹ₜ is performed. In the 1₁ distance calculation processing 340, the absolute distance between F_{t-1→t} (dᵢ) and F¹ₜ is calculated as follows. Such calculation of the distance is performed for each depth value dᵢ.

$$4 DCV ( {d}_{i} , c , x , y ) = \vert {F}_{t - 1 \to t} ( {d}_{i} ) - {{F}^{1}}_{t} ( c , x , y ) \vert$$

4DCV calculated in this manner is referred to as a four-dimensional cost volume 345. x and y are coordinate values in the spatial direction. c represents a channel dimension. By calculating such a distance for each depth value, each coordinate value in the spatial direction, and each channel, the four-dimensional cost volume 345 is obtained. Such a four-dimensional cost volume 345 can be generated by a method similar to Watson.

The four-dimensional cost volume 345 obtained in this manner is input to the network 350 that generates the feature indicating a distribution of values in the depth direction. The network 350 outputs a Channel-wise Motion Feature 355. The Channel-wise Motion Feature 355 is obtained by aggregating three-dimensional information for each channel. More specifically, the network 350 is a three-dimensional normalized network similar to Xu (G. Xu et al. “Iterative Geometry Encoding Volume for Stereo Matching”, Computer Vision and Pattern Recognition 2023, arXiv: 2303.06615.). The four-dimensional cost volume 345 and the feature maps F²ₜ and F³ₜ are input to the network 350. In this manner, the Channel-wise Motion Feature 355 having the elements of C×H/4×W/4 is obtained from the four-dimensional cost volume 345 having the elements of

$$D \times C \times H / 4 \times W / 4.$$

FIG. 4 illustrates an example of a configuration of the network 350. The network 350 is a lightweight three-dimensional convolutional network. As illustrated in FIG. 4, the network 350 includes two Down Sampling Blocks and two Up Sampling Blocks. Each Down Sampling Block includes two three-dimensional convolution operations having a size of 3×3×3. The Up Sampling Block includes a block that performs one three-dimensional transposition convolution operation having a size of 4×4×4 and a block that performs a transposition convolution operation having a size of 4×4×4 and two three-dimensional convolution operations having a size of 3×3×3. In an intermediate layer, Attention of the feature maps F²ₜ and F³ₜ is calculated. This three-dimensional normalization network uses guided cost volume excitation. That is, the feature map Fⁱ matching the scale of the cost volume is converted to be aligned in a channel dimension direction and used as a weight. By using such a feature map weight, the guided cost volume excitation for a cost volume Cᵢ in a scale i is represented as follows.

w=σ(f(Fⁱ))

C′ᵢ=w⊙Cᵢ

Here, f represents two-dimensional point-wise convolution, σ represents a sigmoid function, and ⊙ represents a Hadamard product. In the final layer of the three-dimensional normalized network, the Channel-wise Motion Feature 355 having elements of C×H/4×W/4 is obtained by setting the dimension in the depth direction to 1.

Finally, the Channel-wise Motion Feature 355 is input to the instance segmentation decoder 360. In this manner, a moving object identification mask 365 is obtained as the moving object detection result. As the segmentation decoder 360, an IAM-based decoder disclosed in Cheng (T. Cheng et al. “Sparse Instance Activation for Real-Time Instance Segmentation”, Computer Vision and Pattern Recognition 2022, arXiv: 2203.12827.) can be used.

In the method in the present embodiment, processing with a large calculation amount, such as calculation of Optical Flow and ego flow suppression processing which are performed by Siam, is not required. The third generation unit 250 can use relatively lightweight processing such as processing using a three-dimensional convolutional neural network, when generating the feature indicating the distribution of the values in the depth direction. Therefore, with the method in the present embodiment, it is possible to perform the moving object detection from the image at a high speed.

Evaluation results of the detection accuracy and the detection speed of the moving object using the trained model illustrated in FIG. 3 will be described below. In the following table, evaluation results in the case of using the trained model described in Siam and Cheng are also shown. KITTI and CityScapes data sets were used for model training. The evaluation was performed based on SQ, RQ, and CAQ metrics, and the processing frame rate (FPS). As shown in the following table, with the method in the present embodiment, the detection accuracy that is at a level comparable to that of the Siam method and is superior to that of the Cheng method was obtained. On the other hand, since the number of parameters can be greatly reduced as compared with Siam, the detection speed is greatly improved, and a practical frame rate can be realized.

TABLE 1

| | Number of | KITTI | | | | CityScapes | | |
|---|---|---|---|---|---|---|---|---|
| | parameters↓ | FPS↑ | SQ↑ | RQ↑ | CAQ↑ | SQ↑ | RQ↑ | CAQ↑ |
| Present | 35.72M | 26.89 | 77.70 | 52.91 | 41.12 | 74.45 | 55.17 | 41.07 |
| embodiment | | | | | | | | |
| Siam | 282.43M | 6.23 | 82.4 | 75.4 | 62.1 | 78.0 | 65.2 | 43.8 |
| Cheng | 35.73M | 47.62 | 77.19 | 28.96 | 22.35 | 70.18 | 29.96 | 21.03 |

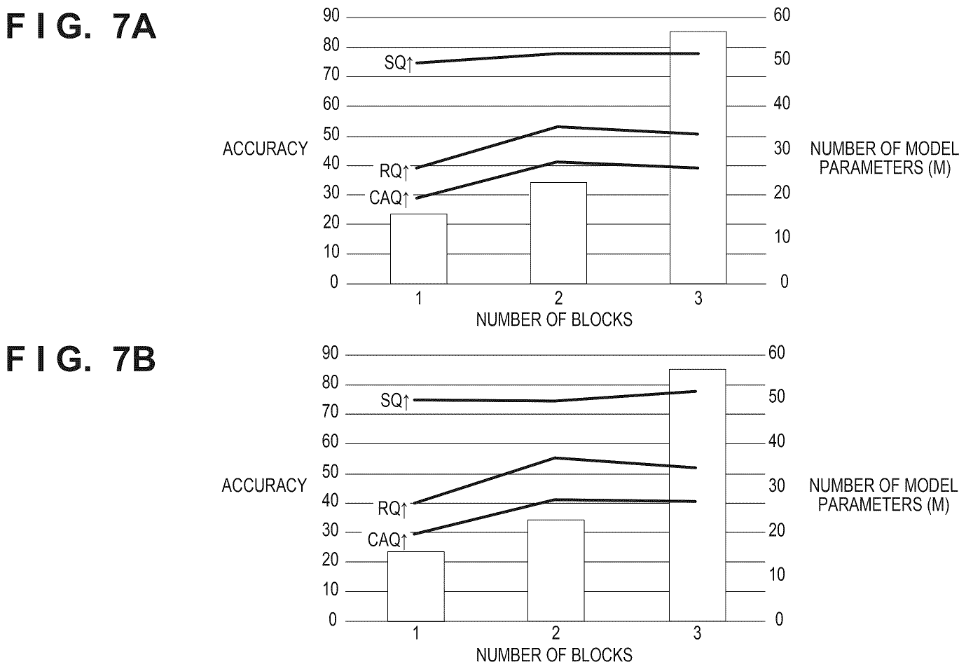

FIGS. 7A and 7B illustrate the number of parameters and the detection accuracy when the number of blocks included in the network 350 is changed. In FIGS. 7A and 7B, the number of blocks indicates the number of sets of Down Sampling Blocks and Up Sampling Blocks. For example, when the network 350 has two Down Sampling Blocks and two Up Sampling Blocks, the number of blocks is two. The accuracy is SQ, RQ, and CAQ metrics, and is indicated by a line graph. The number of model parameters is the number of parameters other than the Pose Network 310, which is used by the trained model illustrated in FIG. 3, and is indicated by a bar graph. FIG. 7A illustrates evaluation results when training is performed using the KITTI data set. As described above, the detection accuracy is greatly improved by increasing the number of blocks from 1 to 2. On the other hand, even when the number of blocks was increased from 2 to 3, the detection accuracy was not significantly improved, but the number of parameters was increased. As described above, by setting the number of blocks to two, it is possible to realize both high accuracy and low calculation cost. FIG. 7B illustrates evaluation results when training is performed using the CityScapes data set. In this case, similarly, by setting the number of blocks to two, it is possible to realize both high accuracy and low calculation cost.

The training of the model as illustrated in FIG. 3 can be performed in accordance with a standard method. For example, a set of each image (training image) and a detection result (supervisory data) of a moving object in a plurality of frames can be used. The model can be trained based on an error between the evaluation result of the model for the training image and the supervisory data. An error back propagation method can be used to train the model. A model trained in advance may be used as a model for determining a posture change of an image capturing apparatus such as the Pose Network 310.

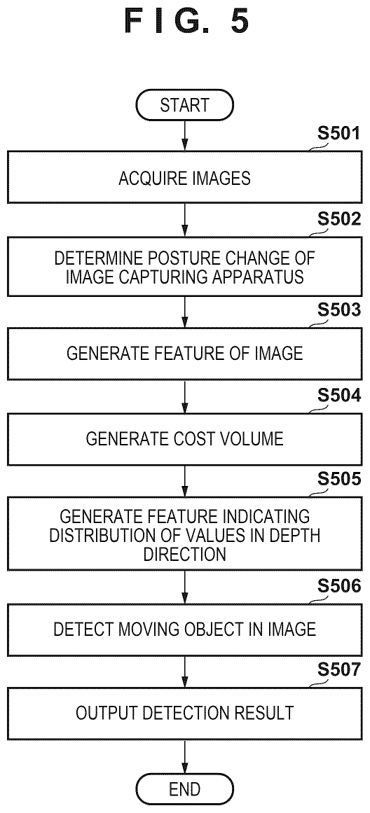

Next, each step of the detection method according to the embodiment will be described with reference to the flowchart of FIG. 5. In S501, the image acquisition unit 210 acquires each image in a plurality of frames as described above. In S502, the determination unit 220 determines a posture change of the image capturing apparatus that has captured an image between a plurality of frames as described above.

In S503, the first generation unit 230 generates the feature of each image in the plurality of frames as described above. In S504, the second generation unit 240 generates the cost volume as described above. In S505, the third generation unit 250 generates the feature indicating a distribution of the values in the depth direction in the cost volume as described above. In S506, the detection unit 260 detects a moving object in an image based on the feature indicating the distribution of the values in the depth direction. In S507, the output unit 270 outputs the detection result of a moving object.

In the above embodiment, the cost volume is generated based on the image It and the image Iₜ₋₁ of two frames. On the other hand, the cost volume may be generated based on images of three or more frames. For example, the second generation unit 240 may generate the cost volume further based on a difference between the warped feature map and the feature map F¹ₜ for an image of a further frame.

### [Mounting on Vehicle]

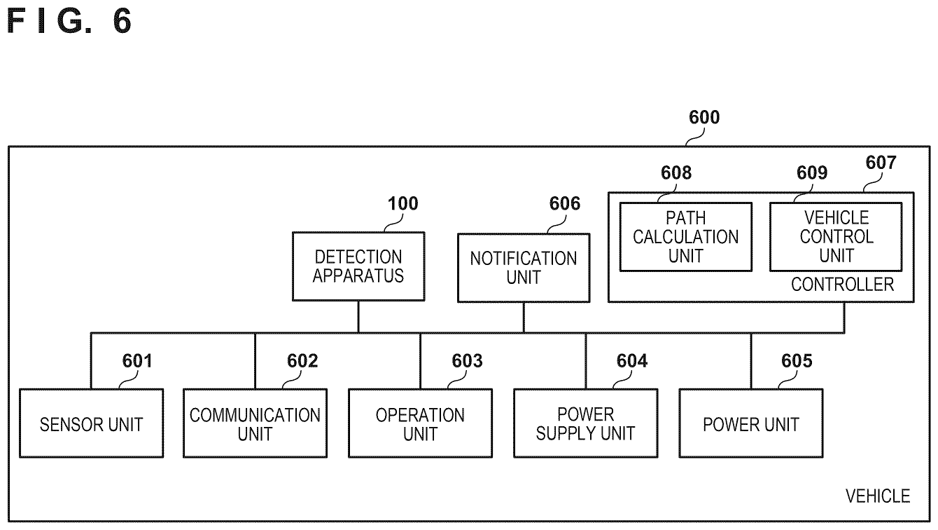

The detection apparatus 100 according to the above embodiment can be mounted on a vehicle. For example, the vehicle may have an automated driving system or an emergency avoidance system. These systems can control the operation of the vehicle based on the detection result of a moving object by the detection apparatus 100. An example of a configuration of such a vehicle will be described below with reference to FIG. 6.

In the following example, a case where the detection apparatus 100 is incorporated in a vehicle 600 will be described. The vehicle 600 may include a control module or an information processing device having the function of the detection apparatus 100.

A sensor unit 601 includes a camera (an image capturing apparatus) that outputs a captured image of a forward view (or captured images of a side view and a rear view) from the vehicle 600. The sensor unit 601 may include various sensors that output acceleration, position information, a steering angle, and the like of the vehicle 600.

A communication unit 602 is a communication device including, for example, a communication circuit, and communicates with an information processing server 150, a transportation system located around the vehicle, and the like through, for example, mobile communication standardized as Long Term Evolution (LTE), LTE-Advanced, or 5G. The communication unit 602 can acquire a learned parameter or the like of a trained model used by the detection apparatus 100 from an external information processing server.

An operation unit 603 includes operation members and members that receive input for driving the vehicle 600. Examples of the operation members include a button and a touch panel installed in the vehicle 600. Examples of the members that receive such input include a steering wheel and a brake pedal.

A power supply unit 604 includes a battery including, for example, a lithium-ion battery, and supplies electric power to each unit in the vehicle 600. A power unit 605 includes, for example, an engine or a motor that generates power for causing the vehicle to travel.

A notification unit 606 can notify the driver of a predetermined sound such as a warning sound or notify the driver of the warning by another method. For example, when the possibility of collision with a target on a road is detected, the notification unit 606 can issue a warning sound. Such a notification operation is performed based on the detection result of a target around the vehicle 600.

The controller 607 is an electronic circuit that performs control of the vehicle 600 including driving assistance of the vehicle 600. For example, the controller 607 can control driving (acceleration) of the vehicle 600 by controlling a power unit. By controlling a hydraulic device, the controller 607 can control braking (deceleration) of the vehicle 600. Further, by controlling an electric power steering device, the controller 607 can control the steering of the vehicle 600.

The controller 607 can perform driving assistance of the vehicle 600. Examples of the driving assistance include acceleration and deceleration assistance, lane keeping assistance, and lane change assistance. The acceleration and deceleration assistance is driving assistance (adaptive cruise control (ACC)) that controls acceleration and deceleration of the vehicle 600 within a predetermined vehicle speed while maintaining an inter-vehicle distance to a preceding vehicle, by controlling the power unit and the hydraulic device. The lane keeping assistance is a driving assistance system (lane keeping assist system (LKAS)) that controls the electric power steering device to keep the vehicle 600 inside the lane. The lane change assistance is driving assistance (auto lane changing (ALC), active lane change assist (ALCA)) for changing the travelling lane of the vehicle 600 to an adjacent lane, by controlling the electric power steering device. The driving assistance may include collision reduction brake that assists avoiding a collision with a target object (for example, a pedestrian, another vehicle, or the like) on a road by controlling the hydraulic device, ABS function, traction control, and/or posture control of the vehicle 600. Such driving assistance is performed based on the detection result of a target around the vehicle 600. On the other hand, the controller 607 may control the power unit, the hydraulic device, and the electric power steering device such that the vehicle 600 performs automated driving toward a destination or following another vehicle based on map information. Such automated driving is also performed based on the detection result of a target around the vehicle 600.

The detection apparatus 100 can detect a moving object around the vehicle 600 as described above, based on the captured image captured by the sensor unit 601. The detection result is transmitted to the controller 607 or the notification unit 606. The controller 607 controls the vehicle based on the detected moving object. For example, the controller 607 can perform driving assistance or automated driving based on the detection result of the moving object. As described above, the combination of the detection apparatus 100 and the controller 607 can function as a vehicle control apparatus that controls the vehicle 600. The notification unit 606 can perform a notification operation based on the detection result of the moving object.

More specifically, the controller 607 can include a path calculation unit 608 and a vehicle control unit 609. The path calculation unit 608 can calculate the travelling path of the vehicle 600 based on the moving object around the vehicle 600, which has been detected as described above. For example, the path calculation unit 608 can calculate the travelling path to avoid another vehicle or another moving object. The path calculation unit 608 may predict the behavior of the moving object based on the detection result of the moving object and calculate the travelling path based on the predicted behavior of the moving object. As described above, the path calculation unit 608 can calculate the optimal path, a risk avoidance path, or the like based on the detection result of the moving object. The vehicle control unit 609 can control vehicle 600 based on the calculated travelling path. As described above, the vehicle control unit 609 can control the vehicle 600 to travel based on the travelling path, by controlling the power unit, the hydraulic device, the electric power steering device, and the like.

### SUMMARY OF EMBODIMENTS

The embodiments described above disclose at least the apparatus, the detection method, and the non-transitory computer-readable medium as described below.
1. According to an embodiment above, an apparatus comprises a first generation unit (230) configured to generate a feature of each image in a plurality of frames; a second generation unit (240) configured to generate a cost volume (345) indicating likelihood of matching between the plurality of frames for each depth based on the feature of the image; a third generation unit (250) configured to generate a feature (355) indicating a distribution of values in a depth direction in the cost volume (345); and a detection unit (260) configured to detect a moving object in the image based on the feature (355) indicating the distribution of values in the depth direction. This embodiment enables to perform moving object detection from an image at a high speed.
2. In an embodiment above, the cost volume (345) is a four-dimensional cost volume having dimensions in vertical and horizontal directions of the image, the depth direction, and a channel direction. This embodiment can improve the accuracy of moving object detection since these configurations facilitate aggregation of more detailed information in the depth direction from the cost volume.
3. In an embodiment above, the apparatus further comprises a determination unit (220) configured to determine a posture change of an image capturing apparatus that has captured the image between the plurality of frames. This embodiment enables to implement the aforementioned method without a sensor to detect the posture change of the image capturing apparatus.
4. In an embodiment above, the second generation unit (240) is further configured to generate the cost volume (345) based on a difference between a feature map of an image in a first frame and a feature map of an image in a second frame, the feature maps being aligned based on the posture change and each depth. This embodiment can improve the accuracy of moving object detection since these configurations facilitate aggregation of more detailed information in the depth direction from the cost volume.
5. In an embodiment above, a range of the depth is set in advance based on a depth value of the moving object in the image. This embodiment can perform moving object detection from an image at a higher speed.
6. In an embodiment above, the third generation unit (250) is further configured to generate a feature (345) indicating the distribution of values in the depth direction and a distribution of values in a channel direction in the cost volume (345). This embodiment can improve the accuracy of moving object detection since the feature indicates the movement of the object more precisely.
7. In an embodiment above, the third generation unit (250) is further configured to perform convolution processing on the cost volume (345) in the depth direction. This embodiment can improve the accuracy of moving object detection since these configurations facilitate aggregation of more detailed information in the depth direction from the cost volume.
8. In an embodiment above, the third generation unit (250) is further configured to perform convolution processing on the cost volume (345) using a network (350) including a Down Sampling Block and an Up Sampling Block. This embodiment can improve the accuracy of moving object detection since these configurations facilitate aggregation of more detailed information in the depth direction from the cost volume.
9. In an embodiment above, the number of Down Sampling Blocks in the network (350) is two, and the number of Up Sampling Blocks in the network (350) is two. This embodiment leads to both a higher detection accuracy and a lesser computational cost.
10. In an embodiment above, the moving object includes at least one of a vehicle, a person, an animal, or a two-wheeled vehicle. This embodiment provides a moving body detection result suitable for vehicle control.
11. In an embodiment above, the apparatus further comprises a travelling path calculation unit (608) configured to calculate a travelling path of a vehicle based on the detected moving object; and a vehicle control unit (609) configured to control the vehicle based on the calculated travelling path. This embodiment can improve the accuracy of vehicle control since these configurations provide a moving object detection result with an improved real-time performance.
12. In an embodiment above, a detection method performed by a detection apparatus (100) comprises: generating (S503) a feature of each image in a plurality of frames; generating (S504) a cost volume (345) indicating likelihood of matching between the plurality of frames for each depth based on the feature of the image; generating (S505) a feature (355) indicating a distribution of values in a depth direction in the cost volume (345); and detecting (S506) a moving object in the image based on the feature (355) indicating the distribution of values in the depth direction. This embodiment enables to perform moving object detection from an image at a high speed.
13. In an embodiment above, a non-transitory computer-readable medium stores a program executable by a computer to perform a method comprising: generating (S504) a cost volume (345) indicating likelihood of matching between the plurality of frames for each depth based on the feature of the image; generating (S505) a feature (355) indicating a distribution of values in a depth direction in the cost volume (345); and detecting (S506) a moving object in the image based on the feature (355) indicating the distribution of values in the depth direction. This embodiment enables to perform moving object detection from an image at a high speed.

The invention is not limited to the foregoing embodiments, and various variations/changes are possible within the spirit of the invention.

What is claimed is:

1. An apparatus comprising one or more memories storing instructions and one or more processors that execute the instructions to:
generate a feature of each image in a plurality of frames;
generate a cost volume indicating likelihood of matching between the plurality of frames for each depth based on the feature of the image;
generate a feature indicating a distribution of values in a depth direction in the cost volume; and
detect a moving object in the image based on the feature indicating the distribution of values in the depth direction.

2. The apparatus according to claim 1, wherein the cost volume is a four-dimensional cost volume having dimensions in vertical and horizontal directions of the image, the depth direction, and a channel direction.

3. The apparatus according to claim 1, wherein the one or more processors execute the instructions to determine a posture change of an image capturing apparatus that has captured the image between the plurality of frames.

4. The apparatus according to claim 3, wherein the one or more processors execute the instructions to generate the cost volume based on a difference between a feature map of an image in a first frame and a feature map of an image in a second frame, the feature maps being aligned based on the posture change and each depth.

5. The apparatus according to claim 1, wherein a range of the depth is set in advance based on a depth value of the moving object in the image.

6. The apparatus according to claim 1, wherein the one or more processors execute the instructions to generate a feature indicating the distribution of values in the depth direction and a distribution of values in a channel direction in the cost volume.

7. The apparatus according to claim 1, wherein the one or more processors execute the instructions to perform convolution processing on the cost volume in the depth direction.

8. The apparatus according to claim 1, wherein the one or more processors execute the instructions to perform convolution processing on the cost volume using a network including a Down Sampling Block and an Up Sampling Block.

9. The apparatus according to claim 8, wherein the number of Down Sampling Blocks in the network is two, and the number of Up Sampling Blocks in the network is two.

10. The apparatus according to claim 1, wherein the moving object includes at least one of a vehicle, a person, an animal, or a two-wheeled vehicle.

11. The apparatus according to claim 1, wherein the one or more processors execute the instructions to:
calculate a travelling path of a vehicle based on the detected moving object; and
control the vehicle based on the calculated travelling path.

12. A detection method comprising:
generating a feature of each image in a plurality of frames;
generating a cost volume indicating likelihood of matching between the plurality of frames for each depth based on the feature of the image;
generating a feature indicating a distribution of values in a depth direction in the cost volume; and
detecting a moving object in the image based on the feature indicating the distribution of values in the depth direction.

13. A non-transitory computer-readable medium storing a program executable by a computer to perform a method comprising:
generating a feature of each image in a plurality of frames;
generating a cost volume indicating likelihood of matching between the plurality of frames for each depth based on the feature of the image;
generating a feature indicating a distribution of values in a depth direction in the cost volume; and
detecting a moving object in the image based on the feature indicating the distribution of values in the depth direction.
